(19) United States
(12) Patent Application Publication
(10) Pub. No.: US 2026/0160508 A1
(43) Pub. Date: Jun. 11, 2026

(54) Universal Service Arm and Rig and Related Tools for Cleaning Inner Surface of Heat Exchanger and other Chemical Reactor Tubes

(71) Applicant: Tubemaster, Inc., Louisville, KY (US)

(72) Inventors: Clifford L Johns, Louisville, KY (US); David L Dingman, Louisville, KY (US)

(73) Assignee: Tubemaster, Inc., Louisville, KY (US)

(21) Appl. No.: 19/356,951

(22) Filed: Oct. 13, 2025

Related U.S. Application Data
(60) Provisional application No. 63/707,197, filed on Oct. 15, 2024.

(51) Int. Cl. F28G 1/16; B01J 8/06; B24C 1/08; F28G 15/02

(52) U.S. Cl. CPC F28G 1/163; B01J 8/06; B24C 1/08; F28G 15/02; B01J 2208/06

(57) ABSTRACT

A transportable, temporary, field-deployable rig for facilitating grit blasting operations for cleaning chemical reactor tubes includes an articulating universal service arm for controlled manipulation by a user in connection with placement and operation of one or more grit blast nozzle(s) adapted to ensure repeatability and accuracy of placement of the nozzle(s) in a coaxial relationship with the longitudinal axis of the vertical tube(s) to be cleaned. The articulating universal service arm may include one or more adapters, wrists, swivels, pivots, elbows, in combination with end effecters configured to grasp or hold and orient for repetitive tasks tools including the grit blast nozzle. Springs and other biasing devices may be used to reduce physical demands on the operators of the articulating arm.

### CROSS-REFERENCE TO RELATED APPLICATIONS

The present invention claims benefit of priority to U.S. Provisional Pat. App. No. 63/707,197, entitled Universal Service Arm and Rig and Related Tools for Cleaning Inner Surface of Heat Exchanger and other Chemical Reactor Tubes, filed Oct. 15, 2024 (Johns), the entirety of which is incorporated herein by reference in its entirety.

### BACKGROUND

The present invention relates to an arrangement for cleaning the inner surface of heat exchanger tubes, such as the tubes used in a chemical reactor or other type of heat exchanger. More specifically, it relates to a device for facilitating safe and effective grit-blast cleaning of the inner surface of the tubes. Reactor tubes are filled with catalyst material and over time the catalyst material is in need of maintenance, including removal and refilling of the reactor tubes.

Many chemical reactors are essentially large shell and tube heat exchanger vessels, with the reaction occurring inside the tubes and a coolant circulating in the vessel outside the tubes. Some chemical reactions occur in furnace or reformer tubes, which may be a part of a system with from 10 to 5,000 or more such tubes. In any of these reactor vessels, catalyst, typically in the form of pellets, may be loaded into the reactor to facilitate the reaction. The catalyst is replaced periodically.

The reactor tubes may be quite long, housed in a structure several stories tall. In order to replace the catalyst, the old, spent catalyst first must be removed from the reactor tubes. The inner surface of the tubes is then mechanically cleaned to remove any scale formed during the chemical reaction process, as this scale impedes or retards the reaction by slowing down the heat transfer rate.

As discussed in more detail below, the prior art method for removing this scale involves a person clad in protective gear physically pushing the end of a pressurized air hose against one end of a tube to be cleaned. Cleaning or other operations may occur from the top of the reactor or from the bottom of the reactor. Space in these confined areas above and below the reactors and above and below respective domes is limited and use of large equipment to handle the special processes makes execution of tasks difficult and demanding and safety of the workers involved in cleaning the reactors and removing and replacing catalyst in the confined spaces of paramount concern.

During the cleaning process, the user presses a button or lever to initiate the flow of grit-laden pressurized air into the tube and holds it there for a long enough period of time to ensure that the inner surface of the tube is thoroughly cleaned. This task is dirty, tiresome, and prone to mistakes which may damage the tube being cleaned. For instance, if the user gets the axis of the nozzle spraying the grit-laden air misaligned with the axis of the tube being cleaned, he can erode the wall of the tube, even to the point of creating a hole through the wall.

What is needed is a rig capable of reducing the physical demand on the workers while also providing a repeatable and controllable work environment to ensure effective removing of catalyst, cleaning of reactor tubes, and filling of reactor tubes with catalyst to “recharge the reactor” and prepare the reactor for continued use.

Although large robots or robotic equipment are known and used in factories, such devices are typically large and permanently affixed to “monuments” or other foundation or bases and are not capable of being readily deployed from job to job and from site to site. What is needed is a specially designed device capable of being assembled and disassembled at a job site and in the confines of a reactor at both the top and bottom of the reactor to enable operators to perform a variety of repetitive tasks.

### SUMMARY

The present invention relates to an arrangement for grit blasting the scale off the inner surface of reactor tubes in a relatively clean, controlled environment, reducing the opportunity for damage to the reactor tube, and creating a consistent, repeatable cleaning procedure while also enhancing the safety of the workers involved in the process.

An embodiment of the present invention provides a device to mechanically bring a grit blasting nozzle toward an end (top and/or bottom) of the reactor tube and accurately orient the grit blasting nozzle at the end of the reactor tube(s) to be grit blasted. More specifically, the present invention provides a transportable, temporary, field-deployable tube cleaning rig for facilitating grit blasting operations for cleaning chemical reactor tubes. The rig is intended to be alternatively deployable in 1) a “tube top” deployment with the rig located at the top dome or the top of the reactor for blasting tubes in a top-down orientation or direction or 2) “tube bottom” deployment at the bottom of the reactor for cleaning operation in a bottom-up orientation or direction. The rig includes an elongated post or main arm support oriented perpendicular to either the top tube sheet or the bottom tube sheet and generally parallel with the tubes being cleaned. The rig includes a bottom post base or lower post mount plate for securing the post at a bottom position relative to the tube sheet and an upper post base or upper post mount plate for securing the upper end of the post. Depending on the operational deployment the upper or lower post base or mounting plate may include a tube pin for partial insertion into a tube along the tube sheet for alignment and securement of the post. The opposite end of the post, i.e, the other of the upper or lower post base or mounting plate may include a securement member for securing to the top or bottom dome or other physical feature of the reactor tube being cleaned. A top operational space within the reactor is defined by the top dome and a bottom operational space within the reactor is defined the bottom dome and the lower tubesheet. One or both of the top and bottom domes of the reactor includes an access or manway configured to permit the rig and one or more persons conducting the tube cleaning operation to enter into the operational spaces and assemble the rig for cleaning. Air supply and grit blasting material supply may be introduced by tubes or hoses into the operational spaces for use in cleaning the tubesheets.

A grit blasting nozzle is connected to the grit blasting supply and is manipulated by the operator for insertion into or abutting manner with the tube opening along the upper or lower tubesheets. Because the grit blasting nozzle and hose are heavy and require significant physical demand on the operator during the repetitive process of cleaning the set of tubes in a reactor, the present invention includes a service arm securely attached to the post for supporting the grit blast nozzle and supply hose. The service arm may include a first or main arm or boom that is attached to the post and a second articulating “universal service arm” (“USA”) attached to and extending from the main arm for controlled manipulation by a user in connection with placement and operation of one or more grit blast nozzle(s) adapted to ensure repeatability and accuracy of placement of the nozzle(s) in a coaxial relationship with the longitudinal axis of the vertical tube(s) to be cleaned. The rig may include an elbow connecting the main arm and the articulating USA and may include a wrist component or feature on the USA for grasping or securing the grit blasting nozzle or other tube maintenance or cleaning component. The post supports the free weight of the articulating service arm. The articulating universal service arm may include one or more adapters, wrists, swivels, pivots, elbows, in combination with one or more end effector configured to grasp or hold and orient for repetitive tasks tools including the grit blast nozzle. Springs and other biasing devices may be used to reduce physical demands on the operators of the articulating arm.

The end effector or end-of-arm attachment or tool mechanism, also called a manipulator, provides a means for securing one or more tools to the articulating arm for manipulation, e.g., positioning, of the arm and tool relative to a vertical tube for cleaning. For example, the arm may include a wrist or other fixation device or component configured to matingly secure the end effector in a desired manner, e.g., pivotal or other movement, and receive, e.g., grip, a tool such as a grit blaster nozzle. Sensors and other devices may be included on the articulating arm to provide feedback or to capture information during task performance.

Because reactors may include hundreds or up to tens of thousands of individual vertical tubes, often in a uniform array configuration with equal or predictable spacing, operators are faced with the task of performing thousands of repetitive cleaning operations in confined areas. The compact and easily movable articulating arm provides a powerful tool to reduce the physical demands traditionally imposed on the operators while also making the tasks repeatable with high degree of precision and accuracy. Positioning grit blasting nozzles and equipment to align properly with the vertical tubes is essential to effective tube cleaning and by eliminating or greatly reducing human error from the process the present invention provides an improved apparatus and method resulting in a safer and more efficient and effective solution.

Power supplies and control equipment may be included to enable the USA to lift, hold and secure objects to reduce physical demand on the operator and to ensure a safer work environment. Biasing devices such as springs or air or hydraulic pistons may also be used. Actuators, servo-motors and other devices may be used to move various parts of the USA apparatus during a cleaning operation. A source of power, e.g., electric, hydraulic or pneumatic, may be employed and may also be used to support control equipment. Operator interface components, e.g., switches, triggers, handles, buttons, dials, may be included to facilitate operator manipulation of the USA components, e.g., positioning grit blasting nozzles opposite tubes for cleaning and turning on and off the source of grit blast material introduced into the tube during cleaning operation. Safety components may be included to prevent operation of equipment, e.g., grit blasting, unless certain conditions are confirmed. For example, if the nozzle is not in a proper position directly facing opposite a tube on a tube sheet, then the operator trigger or “on” button will not permit flow of grit blast material—often at great pressure—to prevent a dangerous condition from occurring and prevent damage to equipment and injury to personnel.

This present invention provides the added benefits of reducing the time required to clean a reactor thereby reducing the downtime associated with taking the reactor offline. By preventing injury to personnel and preventing damage to equipment the present invention avoids downtime due to such events.

The present invention provides a specially designed device capable of being assembled and disassembled at a job site and in the confines of a reactor at both the top and bottom of the reactor to enable operators to perform a variety of repetitive tasks. Manholes and other tight entry ways are typically encountered when

### BRIEF DESCRIPTION OF THE DRAWINGS

FIG. 1 is a schematic, section view of a shell and tube type of chemical reactor;

FIG. 2 is a bottom view of the lower tubesheet of the reactor vessel of FIG. 1;

FIG. 3 is a broken away side sectional view of the bottom portion of a typical tube in the reactor vessel of FIG. 1, showing the scale formed on the inner surface of the tube;

FIG. 4 is a partially broken-away, side sectional view of the reactor tube of FIG. 3, (with the scale removed for clarity) and a prior art nozzle for grit blasting the inner surface of the tube, just before the nozzle is inserted inside the tube;

FIG. 5 is the same view as in FIG. 4 but with the prior art nozzle inserted into the bottom end of the reactor tube;

FIG. 6 is the same view as in FIG. 5 but with the prior art nozzle cocked at an angle showing the misalignment that may happen in the prior art arrangement;

FIG. 7 is the same view as in FIG. 5 but showing how the prior art nozzle misses a substantial section of the scale present in the endmost portion of the reactor tube;

FIG. 8 is a schematic side view, partially broken away, of a top or upper dome configuration for grit blasting the inner surface of at least one tube of a reactor vessel in accordance with the present invention; and

FIG. 9 is a schematic side view, partially broken away, of a bottom or lower dome configuration for grit blasting the inner surface of at least one tube of a reactor vessel in accordance with the present invention.

FIG. 10 is a schematic view of an exemplary post-arm combination configuration for use with the present invention.

FIG. 11 is a top-down view of an exemplary post collar component for use in securing the articulating arm to the post in accordance with the present invention.

FIG. 12 is a cross-sectional side view of the exemplary post collar component of FIG. 11.

FIG. 13 is a cross-sectional side view of an exemplary end effector component for use in securing the grit blasting nozzle or other tool with the articulating arm in accordance with the present invention.

FIG. 14 is a top-down view of the exemplary end effector component of FIG. 13.

FIG. 15 is a side view of an exemplary key component for use in securing the grit blasting nozzle or other tool to the end effector component and the articulating arm in accordance with the present invention.

FIG. 16 is a cross-sectional side view of an exemplary tool interface for use with the end effector component for use in securing a tool with the articulating arm in accordance with the present invention.

### DESCRIPTION

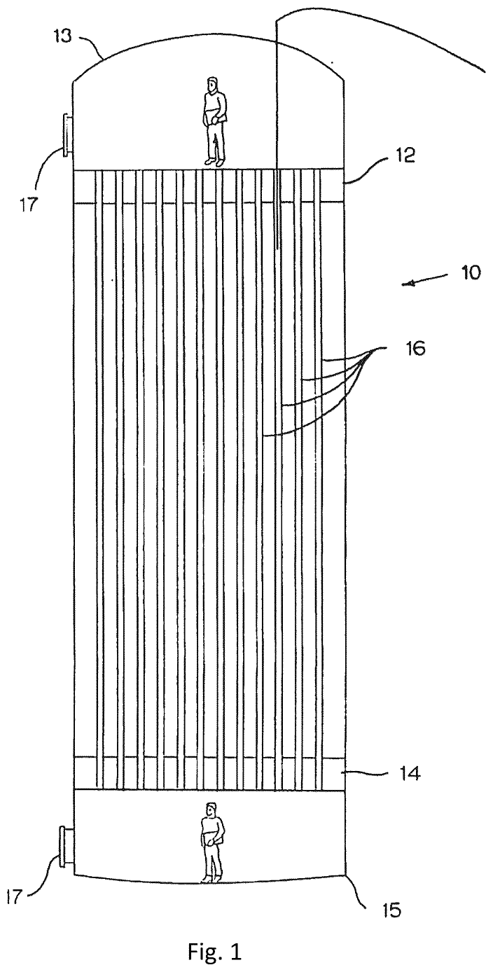

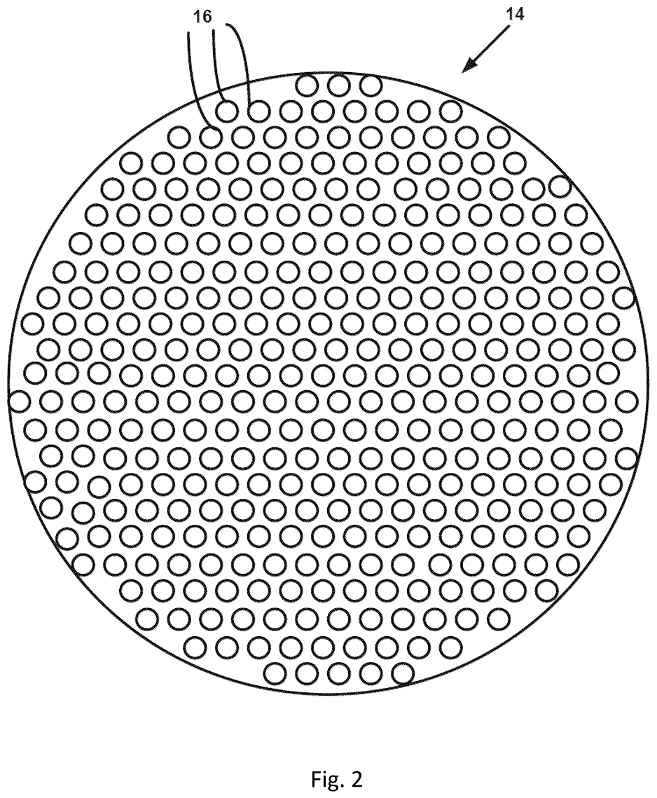

FIG. 1 depicts a typical chemical reactor vessel or “reactor” 10, which is a shell and tube heat exchanger, having an upper tubesheet 12 and a lower tubesheet 14, with a plurality of vertical tubes 16 welded or expanded to the tubesheets 12, 14 to form a tightly packed tube bundle. There may be from one to many hundreds or even thousands of cylindrical tubes 16 (See also FIG. 2) extending between the tubesheets 12, 14. Each tube 16 has a top end secured to the upper tubesheet 12 and a bottom end secured to the lower tubesheet 14, and the tubes 16 are open at both ends, except that there may be a spring, clip or grid at the bottom end of each tube 16 to retain catalyst pellets inside the tube. The upper and lower tubesheets 12, 14 have openings that are the size of the outside diameter of the tubes 16, with each tube 16 being located in respective openings in the upper and lower tubesheets 12, 14.

The vessel 10 includes a top dome (or top head) 13 and a bottom dome (or bottom head) 15, as well as manways 17 for access to the tubesheets 12, 14 inside the vessel 10. The dome accesses or manways 17 are closed during operation of the reactor but are opened for access, such as during catalyst handling and tube cleaning operations. In this instance, the tubes 16 are filled with catalyst pellets, which facilitate the chemical reaction. (It may be noted that similarly-shaped shell and tube heat exchangers may be used for other purposes, such as for a boiler or other heat exchanger, and this arrangement may be used to clean the inner surface of those tubes as well.) Other pellets, such as filler pellets, also may be inside the tubes 16, and they are referred to herein as catalyst pellets as well.

Reactors have either fixed or removable heads. In this embodiment, the heads are fixed, and they include manways 17 at the top and at the bottom in order to provide access to their respective domes.

This particular reactor vessel 10 is fairly typical. Its tubes can range in length from 5 feet to 65 feet, and it is surrounded by a structural steel skid or framework (not shown), which includes stairways or elevators for access to the tubesheet levels of the reactor vessel 10 as well as access to intermediate levels, to a topmost level which may be located at or near the level of the top opening of the reactor vessel 10, and to a lower level which may be located at or near the level of the lower dome 15 of the reactor vessel 10. On a regular basis, which can be every 2 to 48 months or longer, as the catalyst becomes less efficient, less productive, or “poisoned”, it is changed out, with the old catalyst being removed and a new charge of catalyst being installed in the tubes 16 of the reactor vessel 10. Catalyst handling also may have to be done on an emergency basis, on an unplanned and usually undesirable schedule.

A catalyst change operation involves a complete shutdown of the reactor, which may result in considerable cost due to lost production. It is desirable to minimize the amount of time required for the catalyst change operation in order to minimize the lost production and accompanying cost caused by the reactor shutdown as well as for other reasons.

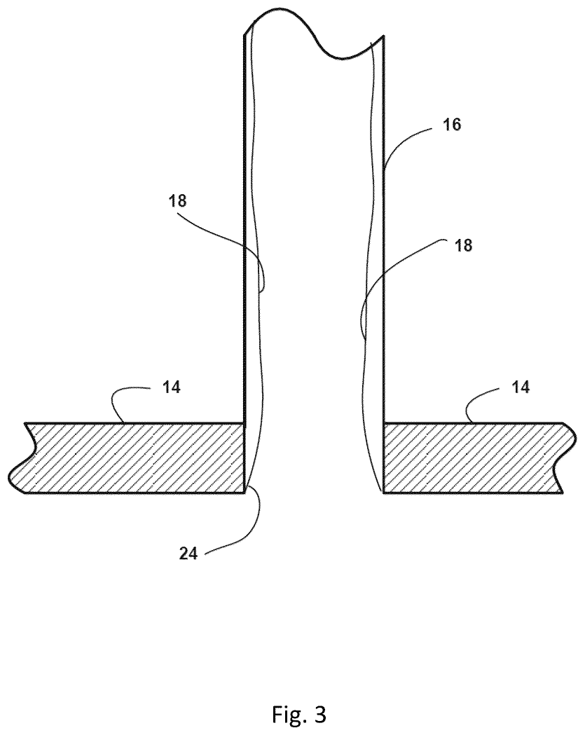

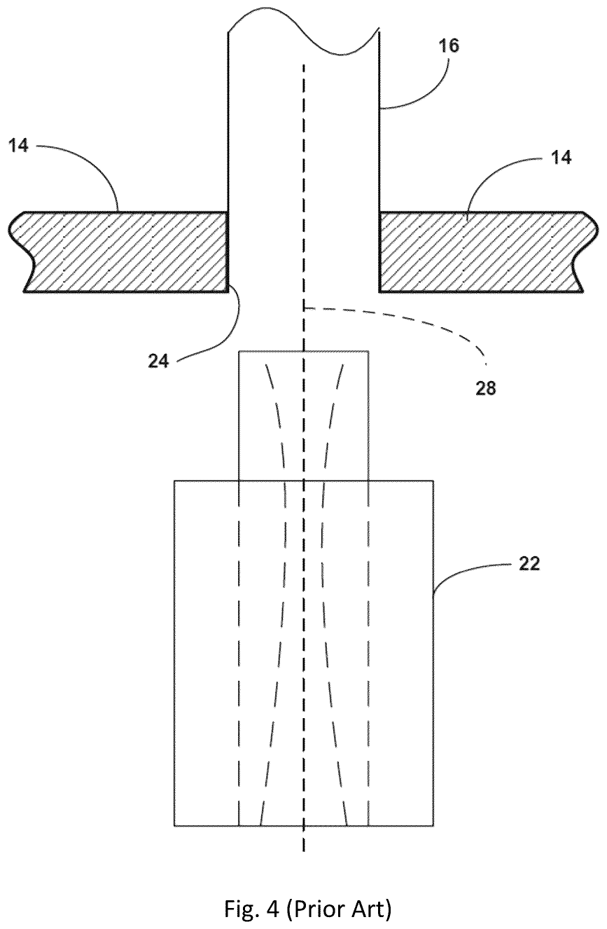

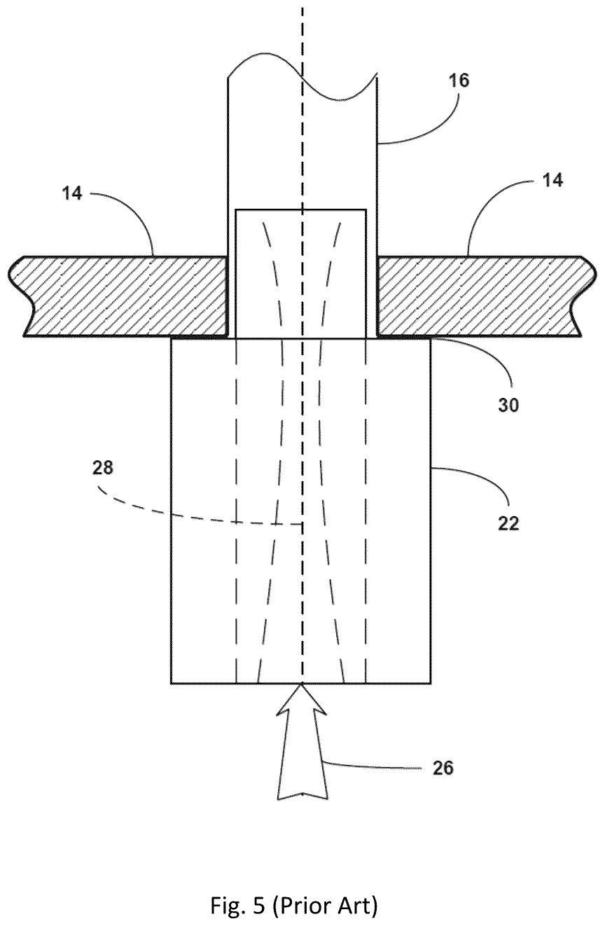

Part of the catalyst change operation involves cleaning the inner surface of the reactor tubes 16 to remove any scale 18 (See FIG. 3) that may have formed inside the tubes 16. The scale 18 inhibits the heat transfer across the wall of the tubes 16, and it is therefore desirable to remove the scale 18 prior to reloading catalyst pellets inside the reactor tubes 16. This cleaning/removal of the scale 18 has traditionally been accomplished by having an operator 20 (See FIG. 1, not to scale), standing on the top tube sheet when grit blasting is to be from the top end of the tube, or with the operator standing in the bottom dome 15 or on a temporary service platform below the bottom tube sheet 14 when grit blasting is to be from the bottom end of the tube. Whether grit blasting is from the top or bottom, in the prior art, the operator physically rams the end of a nozzle 22 (See FIG. 4) into the top end or bottom end 24 of a reactor tube 16 (See also FIG. 5) and then turns on a flow of grit-laden compressed air (represented by the arrow 26) to flow through the nozzle 22 and into the tube 16 being cleaned.

The following description refers to grit blasting from the bottom of the reactor tube 16 toward the top of the tube 16, as shown, for instance, in FIG. 5. However, it should be understood that the grit blasting procedure may be done from the top of the tube 16, blasting grit downwardly toward the bottom end of the tube 16. If the grit blasting procedure is to be done from the top of the tube towards the bottom of the tube, the hoses (such as the compressed air/grit conveying hoses) may be suspended from the top dome 13 (See FIG. 1).

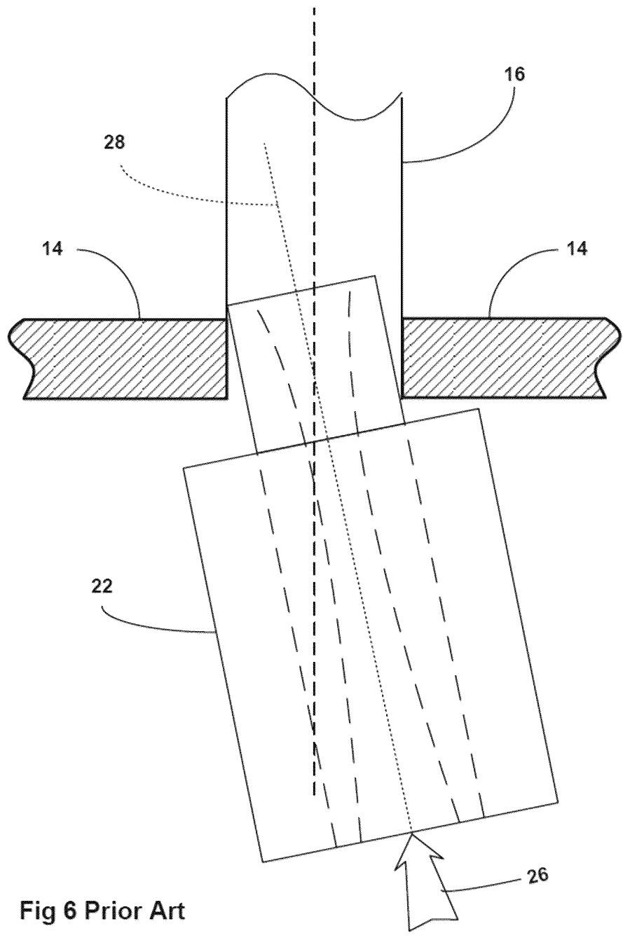

Looking at FIG. 5, in the prior art, the goal of the operator 20 is to ram the nozzle 22 fully against the bottom tubesheet 14 so as to have the longitudinal axis 28 of the nozzle 22 coaxial with the longitudinal axis of the tube 16 in order to reduce misalignment as much as possible. FIG. 6 shows an example of misalignment, which causes severe erosion of the sidewall of the tube 16 in very short order and may even bore a hole through the sidewall of the tube, which is very undesirable.

Unfortunately, this type of misalignment is not unusual in the prior art. The operator 20 may not be paying close enough attention or may not even be aware that the nozzle 22 is misaligned. Imperfections in the surface of the tubesheet 14 in the area of the tube 16 to be cleaned, perhaps due to previous repairs, may result in the misalignment of the nozzle 22. Sometimes operators will purposely “jam” the nozzle at a bit of an angle by propping something against the nozzle and/or the hose which conveys the grit-laden compressed air 26 to the nozzle 22 in order to be able to take a “breather” while the tube is being cleaned. In fact, it has happened that the operator 20 forgets he has propped the grit-laden compressed air 26 in the on position as he goes to take a lunch break, only to return to a major disaster.

If the nozzle 22 is properly oriented with respect to the tube 16, with the longitudinal axis of the nozzle 22 coaxial with the longitudinal axis of the tube 16, as the operator 20 pushes the nozzle 22 against the bottom tubesheet 14, as shown in FIG. 5, he closes off any opening 30 between the nozzle 22 and the surface of the tubesheet 14. If the tube 16 is blocked (by scale or for any other reason, such as fused catalyst which has not been detected and removed), air pressure may build up very quickly inside the tube 16, with the pressurized air having no opening 30 through which to escape. The operator then may lose control of the nozzle 22 as the rising air pressure inside the tube causes the nozzle 22 to be ejected suddenly and with great force, spewing grit-laden compressed air 26 in an uncontrolled manner, which is very undesirable.

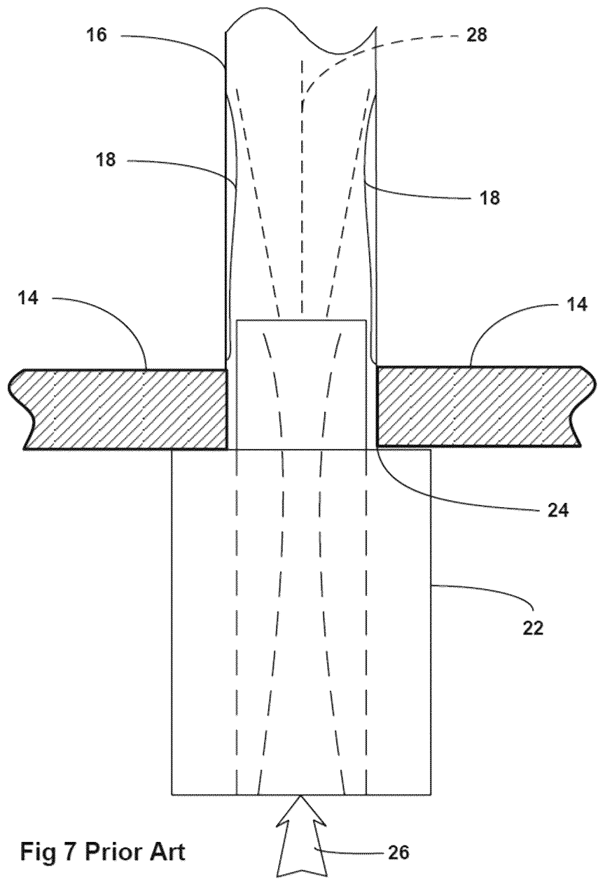

Also, as shown in FIG. 7, as the nozzle 22 is pushed inside the end of the tube 16, the cleaning effect of the grit-laden compressed air 26 does not effectively abrade the scale 18 in a substantial portion of the tube 16 adjacent the end 24 of the tube 16, because the grit-laden compressed air flow path does not spread out enough to touch the inner surface of the tube 16 until a point recessed a substantial longitudinal distance from the end 24.

One exemplary solution to the problems associated with the prior art described above is disclosed in pending U.S. patent application Ser. No. 17/220,283 (Johns), filed Apr. 1, 2021, issued as U.S. Pat. No. 12,228,356, which is incorporated herein by reference and which is commonly owned with the present application.

The following description relates to an improved reactor cleaning apparatus of the present invention, referred to as a field-deployable tube cleaning rig device, that more fully addresses the problems associated with the prior art and improves cleaning operation, repeatability, effectiveness, and enhances safety of personnel.

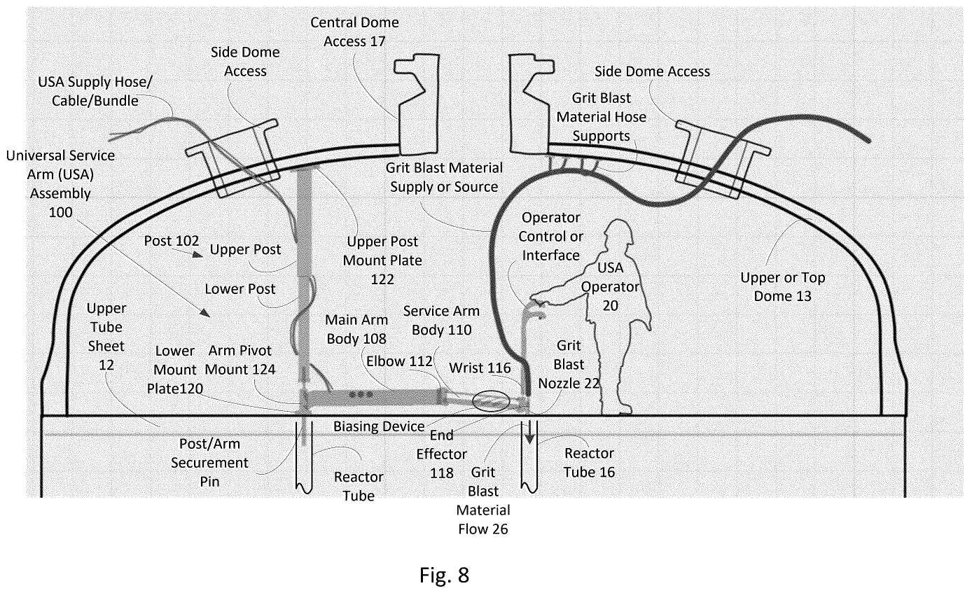

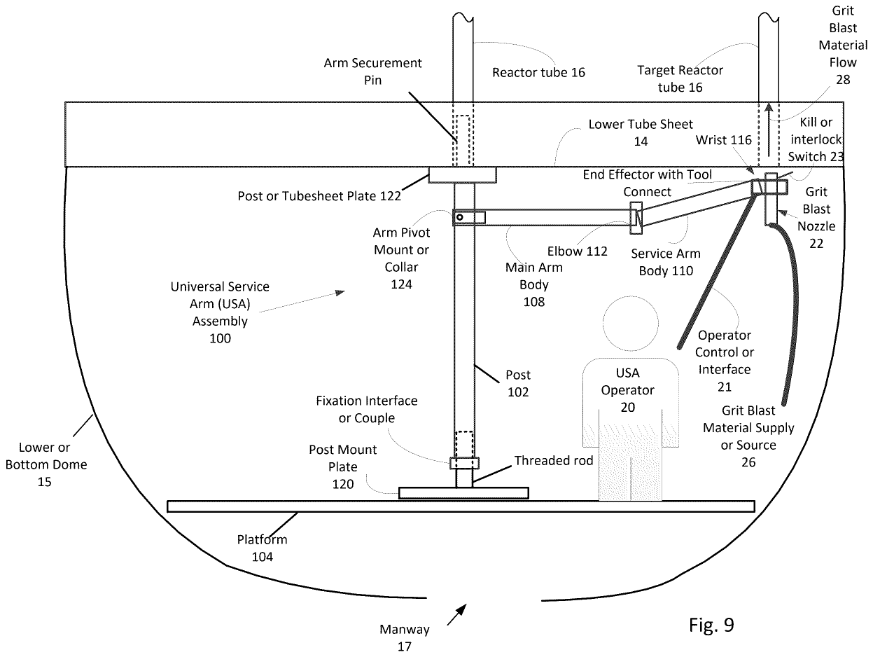

Referring now to FIGS. 8 and 9, the Universal Service Arm (“USA”) Assembly or Apparatus 100 provides a transportable universal service arm apparatus for onsite location at top and/or bottom tubesheets of a reactor and for use in performing repetitive tasks across an array of tubes in a reactor, the universal service arm includes one or more combinations of the following components. One or more post or post member 102 secured to a fixed portion of the reactor, e.g., the upper tubesheet 12 or lower tubesheet 14 and/or the upper dome 13 or lower dome 15 or a platform 104 fixed to the upper dome 13 or lower dome 15. An articulating arm 106 secured to the post member 102, the articulating arm may include a main arm member 108 and a service arm member 110. An elbow 112 or other articulating joint may be provided intermediate or connecting one or more portions of the articulating arm, e.g., an elbow connecting the main arm body and the service arm body member. A tool support member 114 is connected to the articulating arm and adapted to grasp, hold or secure a tool, e.g., a grit blast nozzle 22. The tool support member 114 may include one or more of a wrist member 116 and an end effector component 118. The wrist member 116 may be adapted to articulate in one or more directions about an end of the articulating arm. The end effector 118 may be adapted to secure one or more tool devices, e.g., a grit blast nozzle 22.

The articulating arm is configured to maintain a desired tool position relative to the orientation of the targeted reactor tube for cleaning, e.g., the tubes are vertical and the articulating arm is generally horizontal relative to the tubesheet. The tool, e.g., nozzle, desired to be oriented so that a flow of grit blasting material is coaxial along a longitudinal axis 28 with the axis of the vertical tube 16 and the center of the nozzle outlet and the output flow of material 26 is preferably on the center of the tube being cleaned. The grit blast nozzle 22 may be mounted on the end effector and projecting outwardly from the service arm. The grit blast nozzle defines a longitudinal axis and, when positioned and properly aligned for tube cleaning, is essentially coaxial with a longitudinal axis 28 of the oppositely facing tube 16.

Referring to FIG. 8, the USA apparatus 100 is shown deployed in the top or upper dome 13 of a reactor 10 for cleaning an array of reactor tubes 16 vertically mounted perpendicular to and between an upper tubesheet 12 and a lower tubesheet 14. The USA 100 includes a post 102, which may be comprised of upper and lower post members, e.g., in telescoping fashion to facilitate transport and deployment, and secured to a fixed portion of the reactor, here the upper tubesheet 12 via a lower mount plate 120 and the upper dome 13 via a post mount plate 122. Of course, known fixation means, e.g., bolts, screws, pins, etc., may be used to secure components as needed. An articulating arm 106 is secured to the post 102, e.g., at lower post member, via a collar or joint or arm pivot mount 124. The articulating arm 106 includes a main arm member 108 and a service arm member 110 connected to one another via an elbow 112. One or more other articulating joint(s) may be provided intermediate or connecting one or more portions of the articulating arm, e.g., an elbow connecting the main arm body and the service arm body member. A tool support member 114 is connected to the articulating arm at the distal end of the service arm and is adapted to grasp, hold or secure a tool, e.g., a grit blast nozzle 22 as shown. The tool support member 114 as shown includes a wrist member 116 and an end effector component 118. The wrist member may be adapted to articulate in one or more directions about an end of the articulating arm. The end effector 118 may be adapted to secure one or more tool devices, e.g., a grit blast nozzle. One or more of the wrist and end effector may be interchangeable to allow for a range of tools and configurations for performing a host of tasks often needed in connection with reactor tube maintenance or filling/removing pellets used in chemical reaction processes.

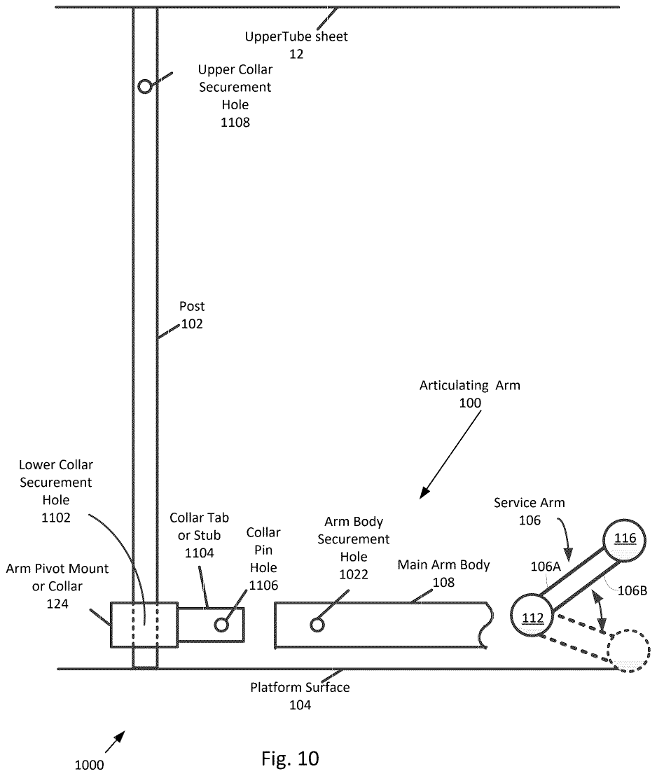

The post member 102 may be secured to the lower tube sheet 14 by use of a pin inserted in a tube as shown and the articulating arm 106 rotates relative to the pin. The articulating arm is shown having a main arm body 108 that maintains a horizontal position and elevation above the tubesheet however the main arm body is allowed to pivot or rotate about the fixation point at the collar or arm pivot mount 124 and about a range of rotation about the post, e.g., 270 degrees about the post and 45 degrees up or down. The main arm body 108 pivots relative to the post 102 and includes a pivot 126 at its distal end to permit pivotal rotation of the service arm member 110 at the elbow 112 allowing the arms to extend away from one another and to collapse in on one another similar to an upper and lower arm of a human. The service arm 110 may be made of two parallel members 110A and 110B as shown in FIG. 10 that are joined to the elbow bracket 112 and to the wrist bracket 116 via pairs of pivot pins that permit vertical stability at the ends, elbow and wrist, one or more springs or pistons may join the two parallel members of the service arm to provide the up and down motion as shown by the arrow. Stops or limits may be included on one or more members to limit range or movement to avoid unwanted hyperextension or over rotation of arm members. For example, the end of the service arm 110 proximal to the main arm body 108 stays relatively fixed at an elevation above/below the upper/lower tubesheets while the distal end of the service arm member moves up and down changing elevation above/below the upper/lower tubesheets to permit movement and deployment of tools during cleaning operation.

As the grit blasting operation involves grit blasting material exiting the nozzle at high pressure (approximately 100 psi) and velocity, a great amount of force is exerted on the tool and the arm. Placing one or more springs or hydraulic springs and/or air cylinders on the service arm member provides needed upward/downward force to counteract the force of the acceleration of the grit blast material through the nozzle and the constant reaction force encountered during grit blasting process. This is important to insure the nozzle is not forced away from the tubesheet due to the high pressure and reactionary force which could result in grit blast material escaping into the surrounding area and damaging equipment or injuring personnel. An interlock or kill switch 23 may be provided on the end effector or tool to confirm contact with the tubesheet is maintained during the grit blasting operation. If the tool moves away from the tubesheet then the flow of material ceases to avoid damage and injury.

The service arm body 110 may include one or more biasing members, e.g., springs or pistons, to aid in lifting the articulating arm and connected tools vertically to facilitate ease in moving from one tube to the next in performing the repetitive task of cleaning thousands of reactor tubes. The biasing device(s) are preferably configured to counter the weight of the attendant devices and components and may be electrically or hydraulically or pneumatically powered. A bundle or set of supply hoses or cables is fed through an access in the dome and fed to the articulating arm for powering the various components. An operator control or interface 21 is provided and may include a handle, a trigger, one or more buttons or switches. The operator 20 guides the articulating service arm 110 by manipulating the control interface 21 to move the tool, e.g., nozzle 22, from one tube to the next and engaging an operation to perform a repetitive task.

For example, here the operator may engage a trigger or push a button to activate and then deactivate the flow of grit blast material into the target tube for cleaning. A safety device or feature may be included as a fail safe to prevent discharge of grit blast material under high pressure when the tool is not properly positioned or aligned with the target tube. A supply of grit blast material is shown being delivered by a hose fed through a dome access port. As shown, the space within a reactor between a dome and a tubesheet is relatively limited and so the USA apparatus with articulating arm is designed for field assembly and with the service arm member folding in toward the main body member helps to provide an economy of motion and range which is useful when operating in a confined space. As reactor cleaning requires cleaning tubes from both the top and the bottom and as many jobs require servicing a plurality of reactors, the compact design and transportable configuration of the USA apparatus provides an efficient solution to address many difficulties in performing this service.

To maintain the tool, e.g., nozzle, in a vertically aligned position relative to the target vertical tube, the service arm member may comprise a pair of parallel members ganged together to articulate in up and down movements to form a parallelogram with sliding action to ensure the end effector and tool remains vertical or orthogonal to the tubesheet with the service arm member is raised and lowered such as during movement from tube to tube. In this manner, the highly repetitive nature of the cleaning operation is simplified by avoiding misalignment often caused by operator error or fatigue or from other device inaccuracies and inability to maintain the vertical orientation of the tool.

Locking and unlocking adaptors may be used to facilitate changing out one end effector or tool for a different end effector or tool.

Referring to FIG. 9, the USA apparatus 100 is shown deployed in the lower dome 15 of a reactor vessel 10 for cleaning an array of reactor tubes 16 vertically mounted perpendicular to and between an upper tubesheet and a lower tubesheet. The USA 100 includes a post 102 secured to a fixed portion of the reactor, here the lower tubesheet via a tubesheet plate and the lower dome via a post mount plate. An articulating arm is secured to the post via an arm pivot mount in an overhead position relative to the operator positioned and standing on the platform. The operator controls movement of the articulating arm via a operator control or interface device much as described in connection with the upper dome scenario of FIG. 8 described above.

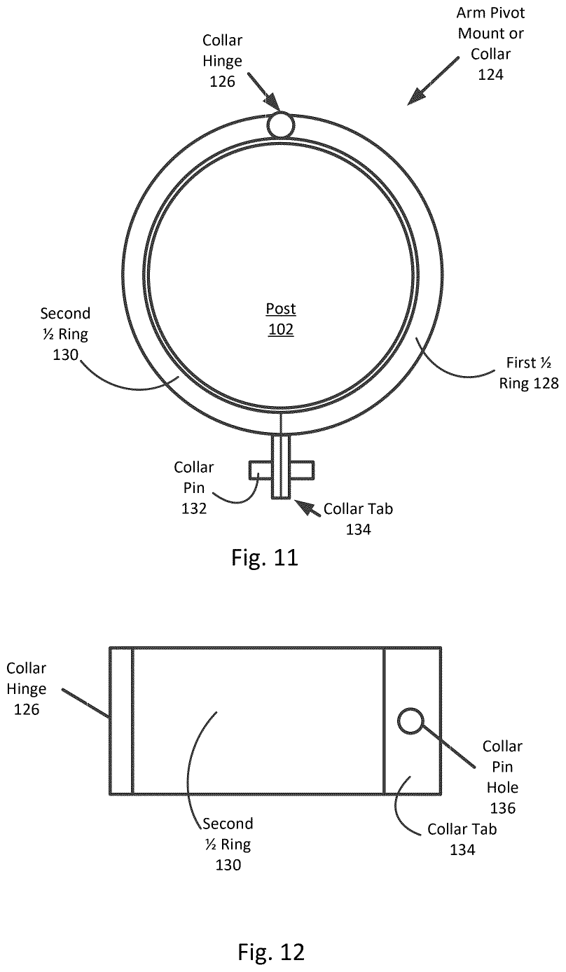

FIGS. 10-12 illustrate an exemplary post-arm configuration 1000 assembled and secured to a lower portion of a reactor. FIG. 10 is a schematic view of an exemplary configuration of a post 102/arm 100 combination 1000 for use with the present invention. FIG. 11 is a top-down view of an exemplary post collar 124 component for use in securing the articulating arm 100 to the post 102 in accordance with the present invention. FIG. 12 is a cross-sectional side view of the exemplary post collar component 124 of FIG. 11.

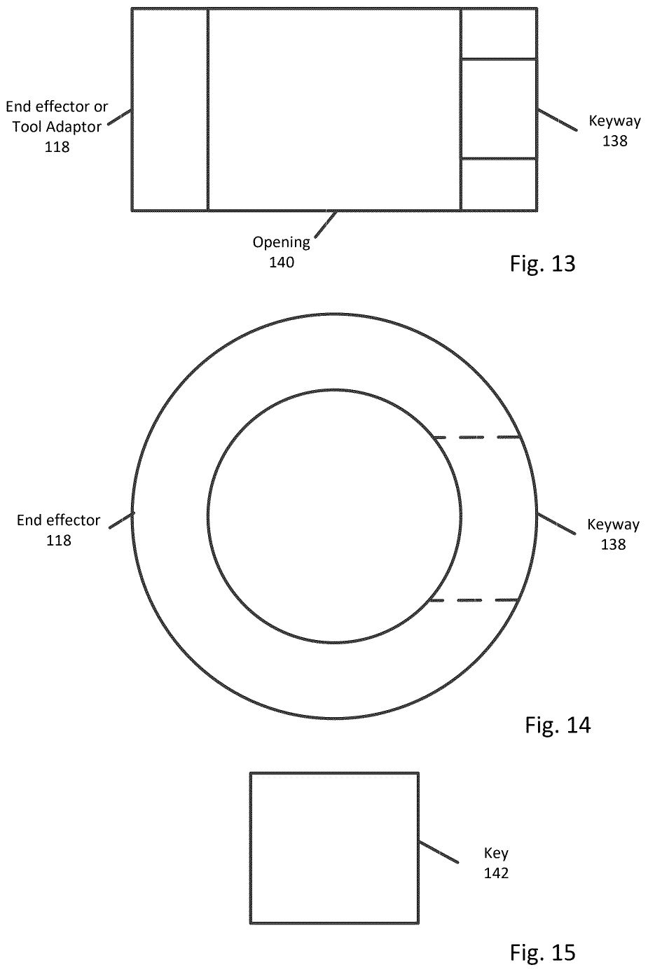

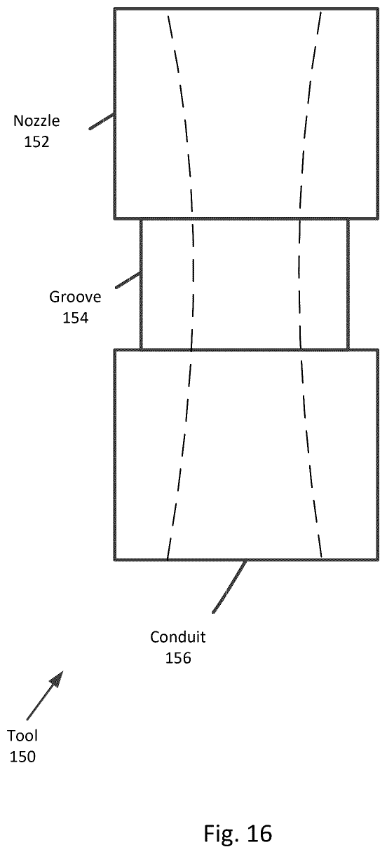

FIGS. 13-16 illustrate an exemplary end effector 118 and tool interface. FIG. 13 is a cross-sectional side view of an exemplary end effector component for use in securing the grit blasting nozzle or other tool with the articulating arm in accordance with the present invention. FIG. 14 is a top-down view of the exemplary end effector component of FIG. 13. FIG. 15 is a side view of an exemplary key component for use in securing the grit blasting nozzle or other tool to the end effector component and the articulating arm in accordance with the present invention. FIG. 16 is a cross-sectional side view of an exemplary tool interface for use with the end effector component for use in securing a tool with the articulating arm in accordance with the present invention. In one example, the tool shown is a grit blast nozzle 152 which is modified by adding a circumferential groove 154 around the outer radius of the nozzle. In use, a tool is inserted into the end effector so its groove is in alignment with the keyway 138. A key 142 is inserted into the keyway extending into the groove causing the tool to be contained in the end effector 118. The groove allows the tool to rotate freely in use which in the case of grit blasting where the tool is a grit blast nozzle which is connected to a supply hose so that the hose does not hinder movement of the nozzle from tube to tube and without which the hose could bind and make nozzle movement difficult depending on which tube is being serviced. The key is secured in the keyway with a pin (not shown) or other fastening device. In cases where it is desired to prevent the tool from rotating in the end effector the tool can also be made with a hole instead of or in addition to a groove. The end effector can include a light (not shown) to illuminate the work area along with an air blowoff hose with nozzle to prevent residual grit from accumulating on the lens of the light.

It will be obvious to those skilled in the art that modifications may be made to the embodiments described above without departing from the scope of the invention as claimed.

What is claimed is:

1. A transportable, temporary, field-deployable tube cleaning rig for facilitating grit blasting operations for cleaning chemical reactor tubes, the reactor tubes mounted perpendicular to top and bottom tubesheets, the cleaning rig comprising:
an elongated post or main arm support having a first end and a second end, the post configured to be received via an access within an operational space of a reactor for tube cleaning operation, the post being oriented perpendicular to a tube sheet and generally parallel with a set of reactor tubes being cleaned with the post secured to physical features of the reactor including, at a first end to the tubesheet;
an articulating service arm adapted to be received into the reactor operational space and to be securely attached to the post at one or more location along the length of the post, whereby with the articulating service arm attached to the post, the post supports the free weight of the articulating service arm, the service arm being freely articulable in a range of motion relative to the post;
a grit blast nozzle mounted on the articulating service arm, the articulating service arm adapted to be manipulated by an operator for positioning the grit blast nozzle along the surface of the tubesheet at a plurality of tube locations for sequential alignment of the grit blast nozzle with each of the plurality of tubes for sequential cleaning of the tubes.

2. The field-deployable tube cleaning rig device of claim 1, wherein the service arm may includes a first or main arm or boom that is attached to the post and a second articulating “universal service arm” (“USA”) attached to and extending from the main arm for controlled manipulation by a user in connection with placement and operation of the grit blast nozzle.

3. The field-deployable tube cleaning rig device of claim 2, wherein the service arm includes an elbow connecting the main arm and the articulating USA.

4. The field-deployable tube cleaning rig device of claim 3, wherein the service arm includes a wrist component or feature on the USA for grasping or securing the grit blasting nozzle.

5. The field-deployable tube cleaning rig device of claim 1 further comprising an end effector adapted to be secured to the service arm and configured to grasp or hold and orient for repetitive tasks one or more tools including the grit blast nozzle.

6. The field-deployable tube cleaning rig device of claim 1 further comprising a set of one or more tools having a common or universal securement feature for mating attachment to the end effector.

7. The field-deployable tube cleaning rig device of claim 1 further comprising a set of one or more sensors disposed on the service arm to capture feedback or other information during task performance.

8. The field-deployable tube cleaning rig device of claim 1 further comprising one or more spring or biasing device adapted to facilitate movement of the articulating arm during cleaning operation to reduce physical demands on the operators of the articulating arm.

9. The field-deployable tube cleaning rig device of claim 1, wherein the range of motion is a three-dimensional range of motion relative to the post and the tubesheet.

10. The field-deployable tube cleaning rig device of claim 1, wherein the rig is alternatively deployable in 1) a “tube top” deployment with the rig located at the top dome or the top of the reactor for blasting tubes in a top-down orientation or direction or 2) “tube bottom” deployment at the bottom of the reactor for cleaning operation in a bottom-up orientation or direction.

11. The field-deployable tube cleaning rig device of claim 1 further comprising a bottom post base or lower post mount plate for securing the post at a bottom position relative to the tube sheet and an upper post base or upper post mount plate for securing the upper end of the post.

12. The field-deployable tube cleaning rig device of claim 1, wherein, depending on the operational deployment, the upper or lower post base or mounting plate includes a tube pin for partial insertion into a tube along the tube sheet for alignment and securement of the post and the opposite end of the post, the other of the upper or lower post base or mounting plate includes a securement member for securing to the top or bottom dome or other physical feature of the reactor tube being cleaned, wherein a top operational space within the reactor is defined by the top dome and a bottom operational space within the reactor is defined the bottom dome and the lower tubesheet.

13. The field-deployable tube cleaning rig device of claim 1, wherein the grit blasting nozzle is connected to a grit blasting supply and is manipulated by the operator for insertion into or abutting manner with the tube opening along the upper or lower tubesheets.

14. The field-deployable tube cleaning rig device of claim 1 further comprising a control arrangement for controlling the flow of pressurized, grit-laden air to said grit blast nozzle, said control arrangement including at least one pneumatic valve and at least one pressure switch.

15. The field-deployable tube cleaning rig device of claim 1 further comprising a base which supports said positioning post, and an actuator adapted to move said service arm respectively away from and toward said post and up and down relatice to the tubesheet.

16. The field-deployable tube cleaning rig device of claim 15, wherein said actuator is one of a pneumatic actuator or an electro-mechanical actuator.

17. A transportable universal service arm apparatus for onsite deployment at top and/or bottom tubesheets of a reactor and for use in performing repetitive tasks across an array of tubes in a reactor, the universal service arm apparatus comprising:
one or more post member secured to a fixed portion of the reactor;
an articulating arm secured to the post member, the articulating arm having a main arm member and a service arm member;
an articulating joint provided intermediate one or more portions of the articulating arm;
a tool support member connected to the articulating arm and adapted to grasp, hold or secure a tool, the tool support member
wherein the articulating arm is configured to maintain a desired tool position relative to the orientation of the targeted reactor tube for cleaning, the tool being a grit blast nozzle and being oriented so that a flow of grit blasting material is coaxial with the axis of the vertical tube and the center of the nozzle outlet or output flow of material is on the center of the tube being cleaned.

18. The transportable universal service arm apparatus of claim 17, wherein the articulating joint includes one or more of a wrist member and an end effector component, the wrist member adapted to articulate in one or more directions about an end of the articulating arm, the end effector adapted to secure one or more tool devices.

19. The transportable universal service arm apparatus of claim 17, wherein, the grit blast nozzle mounted on said end effector and projecting outwardly from said service arm, said grit blast nozzle defining a longitudinal axis and, when positioned and properly aligned for tube cleaning, being essentially coaxial with a longitudinal axis of the oppositely facing tube.

20. The transportable universal service arm apparatus of claim 19, wherein the grit blast nozzle includes a kill or interlock switch adapted to contact the tubesheet or tube during cleaning operation to allow or disallow flow of grit blast material.
